(19) United States
(12) Patent Application Publication
(10) Pub. No.: US 2020/0273369 A1
(43) Pub. Date: Aug. 27, 2020

(54) Cays Digest

(71) Applicant: Jacinta Lawson, New York, NY (US)

(72) Inventor: Jacinta Lawson, New York, NY (US)

(21) Appl. No.: 16/284,911

(22) Filed: Feb. 25, 2019

(51) Int. Cl. G09B 19/00

(52) U.S. Cl. CPC G09B 19/0092

(57) ABSTRACT

In the past, dolls that drank did not have nor reveal their Digestive Systems or the organs that surround them. Cays will have nearly all its chest and belly area cut out, (see Visible Square:1, in FIGS.:(2, 13-15) then have placed there, see FIG.:(3,16-18), the (see-through Digestive Tube, Stomach and Exit: 2, 6 & 10, of its working Digestive System, as well as a (Left & Right Lungs, Liver, Small & Large Intestines: 3-5, 7 & 8). Then covered with see-through material, revealing Cays moving food from feeding bottles,11, into each organ in Cays's Digestive System.

### CROSS REFERENCE TO RELATED APPLICATIONS

Related applications are listed on the application data sheet, together with being listed in the background of the invention section of this specification.

### BACKGROUND OF THE INVENTION

I was trying to find a way to help children see what happens when we drink. I was able to obtain a published patent with Title: My Dollz Digestive System, PUBLICATION No: US-2019-0009180-A1, and Publication Date Jan. 20, 2019. This is

My PUBLISHED PATENT: whose Title is My Dollz Digestive System, PUBLICATION No: US-2019-0009180-A1 is:
1). a portable see-through Digestive System that allows children who do not want this my patent application Title: Cays Digest but wants to put it on their favorite toy to feed their favorite toy and see and learn how food is processed.
2). This patent application: application Ser. No.: 16/284,911, TITLE OF THE INVENTION: CAYS DIGEST is an improvement to dolls (toys) in the past and an improvement to my published patent, PUBLICATION No: US-2019-0009180-A1, because:
(I). Cays Digest is a doll, toy with a visible and see-through Digestive System.
(II). Cays Digest's is a doll with a Digestive System that processes food fed to it.
(III) Cays Digest's Digestive System is inside its body. And is different but relevant to the digestive system in animals. (See: FIGS. :(3-8) and FIGS. :(16-18).
(IV). Cays Digest has four additional organs (figures), in additions to the: Stomach (6), Large and Small Intestine s(8 & 7), and an Exit-(10), that are also in the Digestive System on my published patent, PUBLICATION No: US-2019-0009180-A1.

The 4 additional organs are: an opening in the doll's mouth: 12, a Right and a Left Lungs: (3 & 4), and a Liver: (5). [Please look at FIGS. :(5-7].
(V). Cays Digest's, Digestive System, processes food in a straight path in order to prevents liquid from remaining inside the doll or toy which could possibly cause an unsanitary condition. However, this failsafe prevents Cays Digest's Digestive System to correctly imitate the way that the human Digestive System processes food.

### VI. Definition:

a). The Iliac Crest is the curved superior border of the ilium, the largest of the three bones that merge to form the os coxa, or hip bone. It is located on the superior (above) and lateral (of, at, toward, or from the side or sides) edge of the ilium very close to the surface of the skin in the hip region in humans. This is from the middle of the top of Cays's right leg to the middle of the top of Cays's left leg.

b). 16—the width from the left Iliac Crest to the right Iliac crest in humans, is the width from the middle of the top of Cays's right leg to the middle of the top of Cays's left leg. Please see FIG.: (9-10).

c). A trapezoid, also known as a trapezium, is a 4-sided shape with two parallel bases that are different lengths. This is observable in FIG. 9.

(d). 17—is the distance from the end of Cays's left shoulder to the end of Cays's right shoulder.

VII). TO FIND THE AREA BELOW 16 ON CAYS. WE CONCLUDE THAT the area below 16 ON CAYS is in the shape of an UPSIDE-DOWN TRAPEZOID. Where 9 is the bottom base (b2) and 16 is the top base(b1) of the TRAPEZOID.
1). The formula for the area of a TRAPEZOID is A=½ (b1+b2) h, where b1 and b2 are the lengths of the bases and h is the height.
2). The height of the trapezoid is the distance between the parallel bases. (see FIG. 10A & FIG. 10B). Draw a line between the bases (16 & 9) and use a measuring device to find the distance.
3). We have agreed that A=½ (b1+b2) h. The Area Below 16, (the groin area) is thusly, estimated as A=½ [LENGTH of (16)+LENGTH of (9)]* [DISTANCE BETWEEN (16) & (9)].
4). 13=⅔ (17), see FIG. 9, FIG. 10A. 13 also=the distance between Cays's ears as 13. It is also the distance between the middle of Cays nipples.

(VIII). Next please refer to FIGS: (9 & 10B) because I want to prove that the Visible Square can be made by:
1). First cutting with a width of 7/6 (2 (Cays's Digestive Tube)) From Cays' puckered (lips,12), down to the bottom of Cays's throat (neck) or the Larynx,Vocal Chords, Epiglottis, Esophagus, Trachea, and Windpipe areas in human. (17, FIG. 9).
2). Then, at 17, cutting the Visual Square (see 13, FIG. 10B), by measuring the distance between Cays's ears or the middle of Cays's nipples and making that the value of 13 or making 13=⅔ Cays's shoulder blade,17, (13=⅔ (17)). Then at 17 cutting the Visual Square with a width of 13, down to Cays Illiac Crest (16).

The Visual Square, VS, will decrease in size below 16, (FIG. 9). And is shaped like an upside-down Trapezoid. Therefore, from 16 to 9, we cut down with an area=½ [LENGTH of (16)+LENGTH of (9)]*[DISTANCE BETWEEN (16) & (9)].

All of this makes it possible for everyone who feeds Cays Digest to observe how Cays Digest processes food in its Digestive System, which is to take food from the feeding bottle (11), into its open mouth (12). Then pass it to its Digestive Tube (2). Then to Cays's Stomach (FIG. 6) then pass behind the Small and Large Intestine (7 & 8) to and out Cays's EXIT,10.

Because Cays Digest's has organs that are visible from outside its body, children will be able to observe how the see-through organs in Cays Digest's Digestive System, which are like organs in their own Digestive System, processes the food it eats. And all of this is the reason I believe that Cays Digest will help & improve children's understanding of what organs are inside their bodies and how their Digestive System, digests food.

Cays Digests with a Closed digestive system details a Cays Digest where Cays Digest's open mouth, 12, be closed and then colored sand enough to fill Cays Digest's Digestive Tube, 2, from its lips to the beginning of Cays's throat would be put inside Cays. Then, users instead of feeding Cays would manipulate Cays in order to make (food), colored sand ,66, FIG. 16 & FIG. 17, travels to all the parts of Cays's Closed digestive system giving users a more kind of accurate view of how food gets digested and avoids the mess and cost of finding liquids to feed Cays, all visible in FIGS.: (16-18).

All of these differences stated above between dolls (toys) in the past my published patent, PUBLICATION No: US-2019-0009180-A1, compared to this, my patent that I am now working on patent application Ser. No.: 16/284,911, Title of Invention: Cays Digest and the fact that Cays Digest is a doll (toy), that has, inside its body, organs that children can see and watch how they work as well as the fact that children will be taught the names of and told they have similar organs inside their own bodies that also works in a similar way, are why I believe that all of these improvements will help children easily understand the human body, the organs inside them and the bodies digestion of food.

### BRIEF SUMMARY OF THE INVENTION

This Patent Application, (application Ser. No.: 16/284,911), whose Title of Invention: is Cays Digest, is a new design of a doll that will help to children understand what happens inside our bodies when we drink. This invention does so by having some of the organs in the human chest and a see-through and visible Digestive System that simulates the Digestive System in the human body.

This patent application Ser. No.: 16/284,911, Cays Digest is different in that it not only has and shows some of the organs that are near the Digestive System in the human body, but Cays Digest's has a visible and see-through Digestive System which travels in a straight path from its mouth, to its stomach then behind its Small and Large Intestine before exiting the doll's, EXIT. The straight path that food travels in Cays Digest prevents liquid from remaining in the doll which could possibly cause an unsanitary situation and is the reason why its working Digestive System is not exactly like the one in humans.

Cays Digest has a see-through design. This see-through design will consist of a cut-out section in the front of Cay Digest's body, a Visible Square [1 FIGS. :(2, 9, 13-15]. And, this Visible Square will be covered with a see-through material and in this Visible Square there will be 7 organs which are (2-8 &10).

Cays Digests with a closed digestive system details a Cays Digest where users instead of feeding Cays would manipulate Cays in order to make colored sand (food) travels to all the parts of Cays's digestive system giving users a more kind of accurate view of how food gets digested and avoids the mess and cost of finding liquids to feed Cays, all Visible in FIGS.: (16-18), 66, is the sand.

### BRIEF DESCRIPTION OF THE SEVERAL VIEWS OF THE DRAWING

The following are ail the listing of all figures with explanation of what each figure depicts:

FIG. 1 is a view of Cays's mouth.

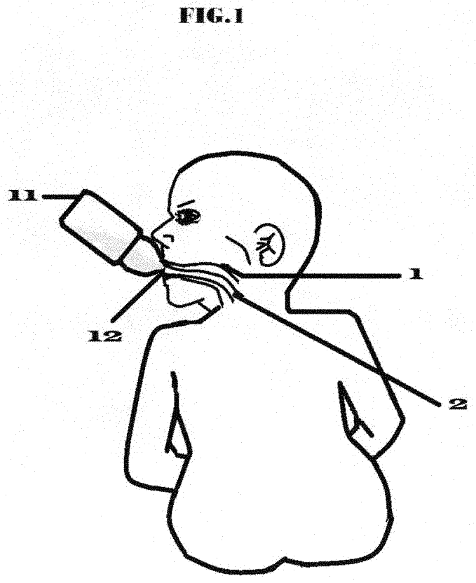

FIG. 2 is a Back view of the Visual Square,I.

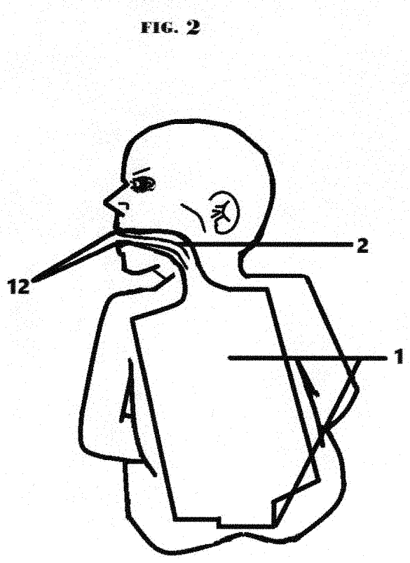

FIG. 3—Back view of the transparent: Digestive tube, Stomach & EXIT.

FIG. 4—Back view of the transparent: Digestive Tube, Stomach, Intestines & Exit.

FIG. 5—a back view of the Digestive Tube,2, Left, 3 & Right, 4, Lungs, Liver,5, Stomach,6, Small ,7, & Large,8, Intestines, & Exit, 10.

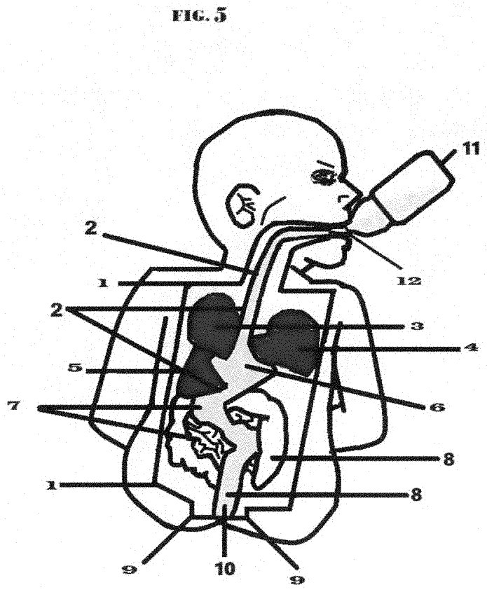

FIG. 6—Front View of Cays Standing showing all-Parts in FIG. 5.

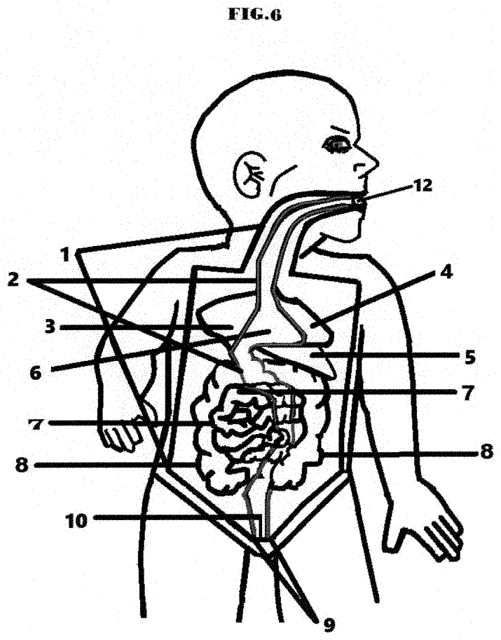

FIG. 7—FRONT—Sitting view of FIG. 5.

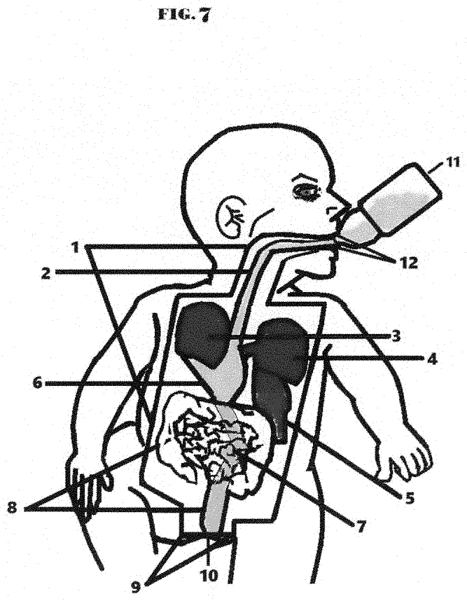

FIG. 8—Digestive Tube & Small & Large Intestines.

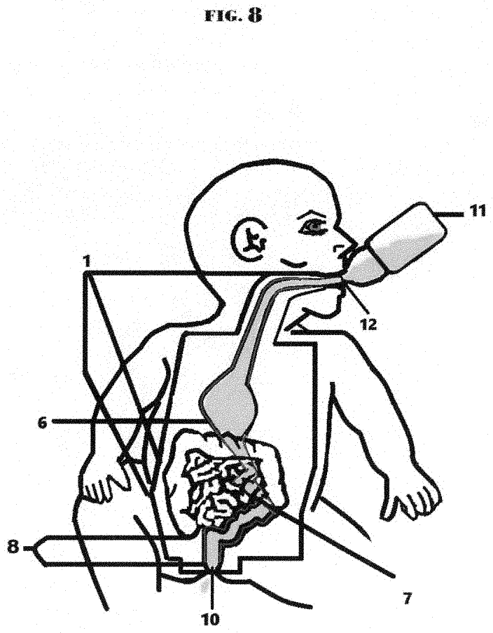

FIG. 9—Cays Digest standing and the Visual Square marked to estimate its measurements.

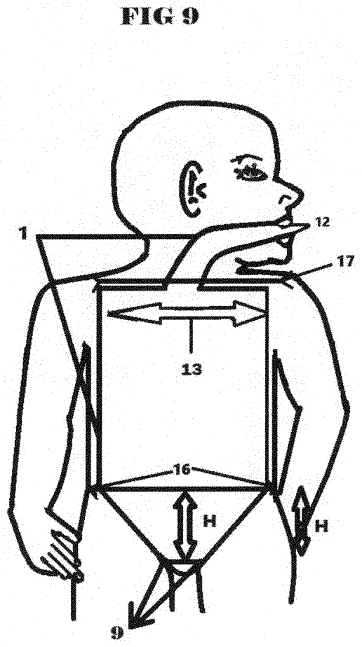

FIG. 10A—Sitting view of Cays Digest with figures used to label parts of the Visual Square necessary to estimate its measurements.

FIG. 10B—a view of Cays Digest standing, and the Visual Square is marked with labels to estimate its measurements.

FIG. 11—example of a Feeding Bottle.

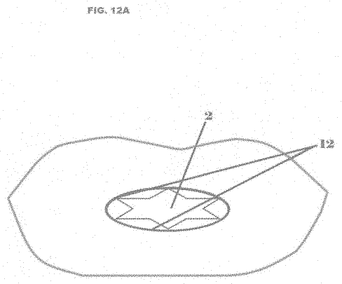

FIG. 12—Front view of the hole in Cays's mouth. Added in order to prove how food is entering Cays Digest.

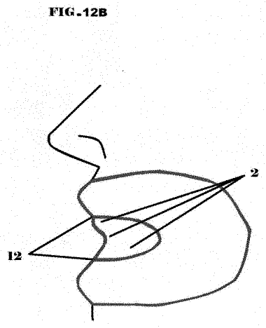

FIG. 13—SIDE VIEW OF FIG. 12.

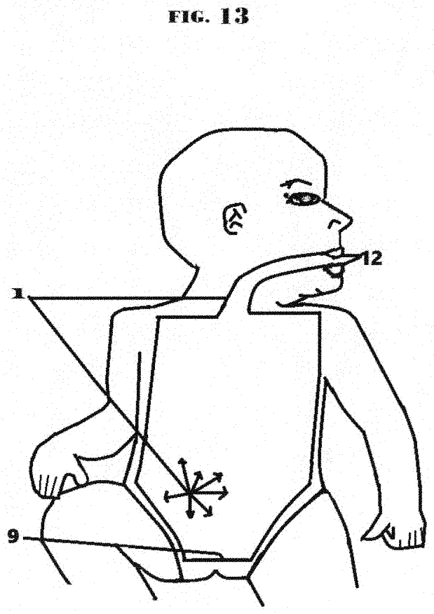

FIG. 14—Another view Cays Digest sitting and showing Just the Visual Square.

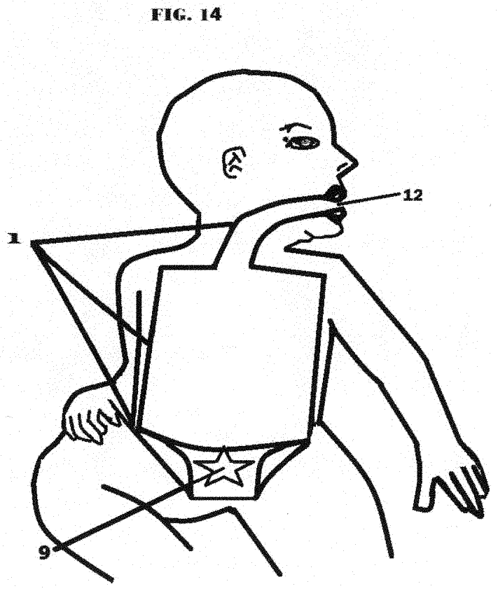

FIG. 15—Cays Digest sitting and showing the Visual Square & the bottle.

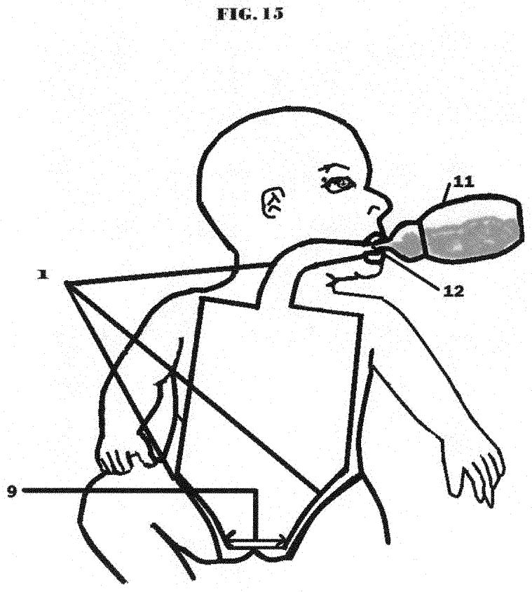

FIG. 16—Cays Digest is sitting, and this is a view of the version of Cays Digests with a Closed digestive system in which Arrows reveal the path sand could take.

FIG. 17—a Back & standing view of the version of Cays Digests with a Closed digestive system in which COLORED SAND reveal the path sand could take.

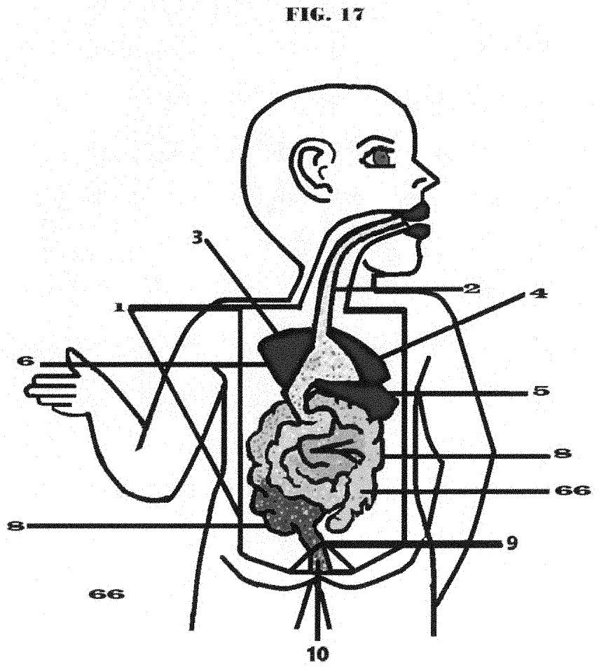

FIG. 18—This is a view of Cays Digest standing and facing front. It is also a view of Cays Digests's Closed digestive system version in which the path of sand is revealed with just the black & white drawing.

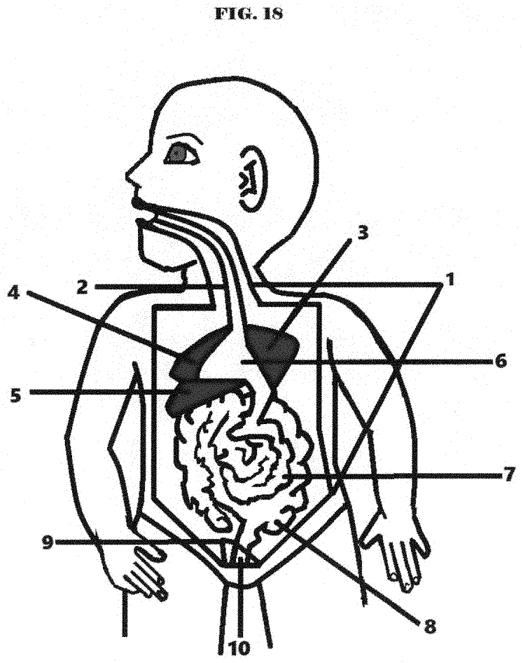

The following are their names and description of the 12 organs or figures that are in Cays Digest Visible in Drawings, (3-8, 9-10B,12-18):
1—Visible Square or the cut out and see-through areas in Cays Digest.
2—see-through (exposed) Digestive Tube.
3—opaque Left Lung.

4—opaque Right Lung.

5—opaque Liver.

6—see-through Stomach.

7—Transparent Small Intestine in Cays Digest.

8—transparent Large Intestine.

9—the bottom base of the Visible Square.

10—the end of the Large Intestine, the last section the Visible Square has made see-through in Cays Digest.

13—the width of the top base of the Visual Square

14—the start of the left side of the visual square and 13.

15—the start of the right side of the visual square & 13.

16—from the middle of the top of Cays's right leg to the middle of the top of Cays's left leg.

17—the distance from the end of Cays's left shoulder to the end of Cays's right shoulder.

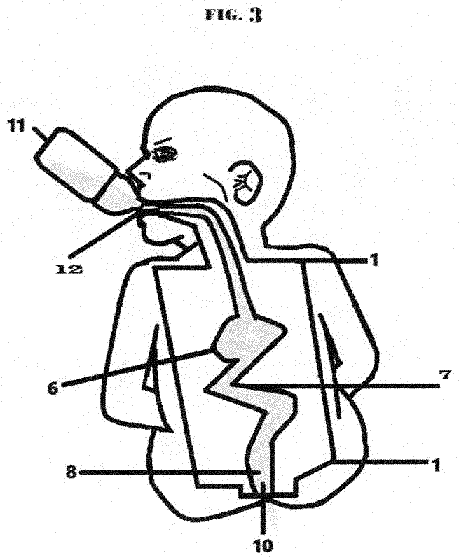

Cays's digestive tube, stomach, & exit design, (see FIG. 3), allows food to travel in a straight road in and out of Cays Digest. FIGS.: 3-8), that is from Cays Digest's mouth,12, into its Digestive Tube, 2, then into its Stomach,6, and then back into the other half of the Digestive Tube, 2, then the Exit, 10. (3,4, & 5) or the (Left lung, Right Lungs & the Liver) are not included because they do not help Cays Digest process or digest food. The following figures are introduced in their drawings, in FIGS.:(9 & 10(A&B), to estimate measurements:

A). (13)—Width of the Virtual Square.

D). 14—width going right from the Left edge of (17) until we reach the left start of (13 and the Visual Square).

C). 15—width going left from the right end of 17, until we reach the start of the right side of (the Visual Square & 13).

B). 17—total width of Cays's Shoulder.

### DETAILED DESCRIPTION OF THE INVENTION

Cays Digest will be dolls(toys) which will be made like all other dolls. The differences are that all dolls (toys) of the type, Cays Digest, will have a mouth with a hole, allowing users to feed it, and this hole will visibly lead to its visible and see-through Digestive Tube which is part of its visible and see-through Digestive System comprising of see-through organs and the organs that it has near its Digestive System. Please refer to [FIGS. :(1-12)].

The see-through organs that comprise Cays Digest's Digestive System will be its see-through:

(1)—Visible Square which holds all the organs.

(2)—Digestive Tube.

(6)—Stomach.

(7)—Small Intestines.

(8)—The Large Intestine.

The rest of Cays organs are listed below and are not transparent:

(12)—Opening in Cays Digest's mouth.

(3)—Left Lung.

(4)—Right Lung.

(5)—Liver.

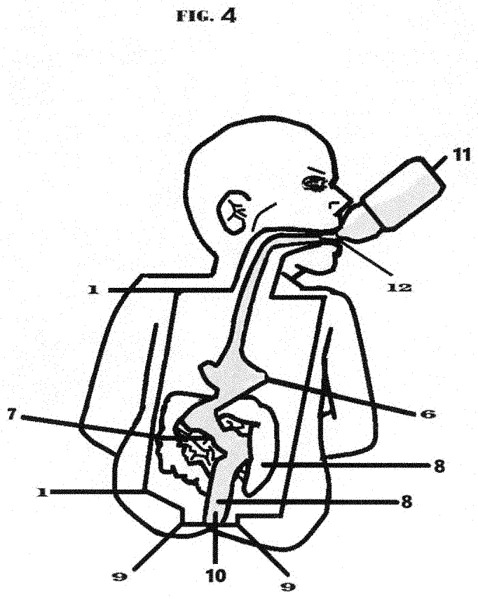

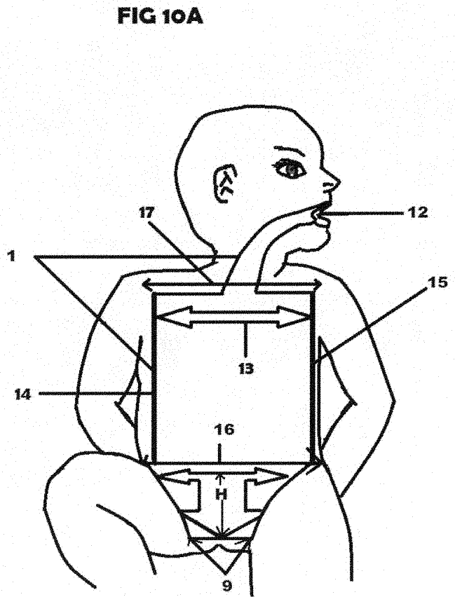

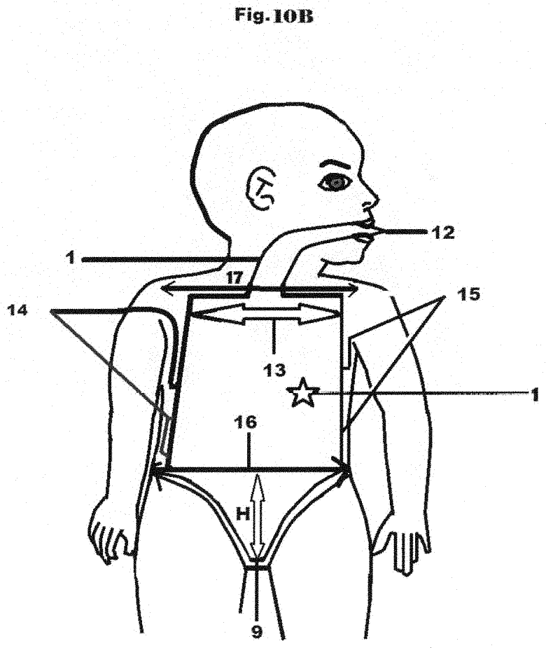

Please make note that the diameter of the Digestive Tube, and EXIT are always the 3/5 the diameter of Cays's throat (neck). Please refer to FIG. 3, FIG. 4, & FIG. 10B, for measurement references in this case.

The width of the Visible Square is 7/6 the diameter of the Digestive Tube after Cays's open mouth (lips) until the Digestive Tube reaches Cays shoulder,17. After that, the Visible Square will be twice as large as Cays Digestive Tube until it reaches the shoulder (17). The Diameter of the Digestive Tube which is always 3/5 the diameter of the throat.

I). VOCABULARY. PLEASE LOOK AT FIGS.: (9 & 10B).
a). 13 starts by going to the right end of (17) and traveling left the distance of ⅙ (the total length of (17)). 13 is then, the distance left from there to ⅙ (17) less that the distance of the left end of (17). Or 13 is the distance at the top of the Visual Square, from the end of Cay's left ear to the end of right ear. 13 is also the distance from where the middle of Cays's left Brest nipple would be to where the middle of the right nipple would be.
b). 14 is ⅙ (17) to the left of the right end of 17. This is where 13 starts on the left side.
c). 15=⅙ (17). This is where 13 starts on the right side.
d). The area or width of the Visual Square,1, shrinks below 16, the groin area.
e). The width of the Visual Square in the groin area (the area below 16) is A=½ (b1+b2) h, where b1 and b2 are the lengths of the bases, 16 & 9, and h is the height from 13 down to 16.

All of this will allow anyone who feeds Cays Digest with a bottle of food to see the food travel from inside Cays Digest's mouth to its Digest-Tube, then down to its Stomach, then another part to its Digestive Tube, then down and behind its Small and Large Intestines until it gets to the bottom part of the Large Intestine which is Cays Digest's EXIT (groin, genitals or anus).

It is important to note that the see-through Digest-Tube, (2), which carries liquid fed to Cays Digest, travel in a straight manner, FIGS.: (3 & 4), from Cays Digest's mouth, to its Stomach, then down behind its Small and Large Intestines, just before reaching and exiting from its EXIT, 10,which is a simulated human genital. This prevents liquid from lingers in Cays. However, it also prevents Cays Digest from accurately simulating the process that the human Digestive System goes through.

The Left and Right Lungs, the Liver, and the Small and Large Intestines, are in Cays Digest for teaching purposes. That is, to let users see organs like theirs which are near and in their Digestive System.

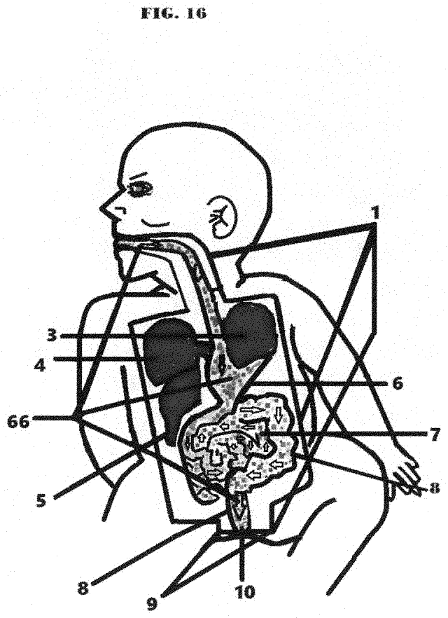

Cays Digest with a closed system means that Cays Digest's open mouth 12, be closed and then have colored sand enough to fill Cays Digest's Digestive Tube, 2, from its lips to the beginning of Cays's throat. This sand, 66, FIG. 16, will replace, the feeding of Cays and children will instead rotate Cays Digest to move the sand from the part of Cays's Digestive Tube that is in its mouth to all the parts that Cays Digestive Tube goes. This includes al parts of the intestines.

1. I claim that making the Digestive System visible in the doll and making this Digestive System work basic or similar to way to the way work in the human body will improve children's understanding of the how the body processes food.
